(19) United States
(12) Patent Application Publication
(10) Pub. No.: US 2009/0143118 A1
(43) Pub. Date: Jun. 4, 2009

(54) INTERNAL ANTENNA FOR MOBILE PHONE AND MANUFACTURING METHOD THEREOF

(76) Inventor: Jang-Hwan Bae, Incheon (KR)

Correspondence Address: IPLA P.A., 3580 WILSHIRE BLVD., 17TH FLOOR, LOS ANGELES, CA, 90010, US

(21) Appl. No.: 10/599,626

(22) PCT Filed: Jun. 19, 2006
(86) PCT No.: PCT/KR06/02342

§ 371 Date: Oct. 3, 2006

(51) Int. Cl. H04M 1/00; H01P 11/00

(52) U.S. Cl. 455/575.7; 29/600

(57) ABSTRACT

A cellular phone antenna and a manufacturing method of the same are disclosed, in which a high frequency characteristic and a product safety are enhanced using a cellular phone antenna which is manufactured by preventing an antenna device from being transformed. The cellular phone antenna comprises an antenna base which is engaged in an interior of a cellular phone; an antenna which is installed at the antenna base; a connection terminal which is connected with the antenna; and a holder which is attached to the antenna base so that the antenna and the connection terminal are connected.

### CROSS REFERENCE

Applicant claims the benefit under 35 U.S.C. Section 365 of International Application PCT/KR2006/002342, filed Jun. 19, 2006.

### TECHNICAL FIELD

The present invention relates to a cellular phone antenna and a manufacturing method of the same, and in particular to a cellular phone antenna and a manufacturing method of the same in which a high frequency characteristic and a product safety are enhanced using a cellular phone antenna which is manufactured by preventing an antenna device from being transformed.

### BACKGROUND ART

Generally, a cellular phone is provided with an antenna for transmitting or receiving radios. An internal antenna, in which an antenna is hidden in an interior of a cellular phone body, has been developed and used.

A conventional internal antenna for a cellular phone is manufactured in such a manner that upper and lower molds are prepared for molding an internal antenna, and an antenna device having a thickness of about 0.5 mm is positioned at the lower mold. The upper mold is engaged with the lower mold. An injection molding is performed using a synthetic resin.

However, in a manufacture of a conventional antenna, a relatively thin antenna device may be transformed due to a high pressure, which occurs by a liquid synthetic resin used during an injection molding process, so that a certain product defect may occur due to a poor high frequency characteristic.

In addition, a conventional antenna is molded at about 450° C. through 1200° C. The above temperature ranges may be good for a metallic material expansion, but a synthetic resin printed with an antenna component may be transformed in the above temperature ranges.

### Technical Problem

Accordingly, it is an object of the present invention to provide a cellular phone antenna and a manufacturing method of the same which overcome the problems encountered in the conventional art.

It is another object of the present invention to provide a cellular phone antenna and a manufacturing method of the same in which a high frequency characteristic and a product safety are enhanced using a cellular phone antenna which is manufactured by preventing an antenna device from being transformed.

### Technical Solution

To achieve the above objects, in a cellular phone antenna engaged in an interior of a cellular phone, there is provided a cellular phone antenna which comprises an antenna base which is engaged in an interior of a cellular phone; an antenna which is installed at the antenna base; a connection terminal which is connected with the antenna; and a holder which is attached to the antenna base so that the antenna and the connection terminal are connected.

To achieve the above objects, there is provided a manufacturing method of a cellular phone antenna which comprises a step S1 in which a rectangular antenna base is prepared; a step S2 in which a silk screen device is provided at an upper side of the antenna base for printing in a certain shape; a step S3 in which a metallic paste is provided at the silk screen device; a step S4 in which the metallic paste is printed on the upper side of the antenna base in a certain shape using a spoon member; a step S5 in which the metallic paste printed on the antenna base is hardened and cured; and a step S6 in which a holder engaged with the connection terminal is attached at the antenna base so that the connection terminal is connected with the antenna hardened on the antenna base.

### ADVANTAGEOUS EFFECTS

Since the antenna according to the present invention is manufactured in a state that an external force is not applied, the antenna is not transformed, so that a high frequency characteristic is not changed, and a degradation problem does not occur. So, the present invention is a very reliable invention.

In addition, a good high frequency characteristic and product safety are obtained since a cellular phone antenna is manufactured in such a manner that an antenna device is not transformed.

### DESCRIPTION OF DRAWINGS

The present invention will become better understood with reference to the accompanying drawings which are given only by way of illustration and thus are not limitative of the present invention, wherein;

FIG. 1 is a perspective view illustrating a silk screen used for manufacturing a cellular phone antenna according to the present invention;

FIG. 2 is a perspective view illustrating a connection terminal before it is attached to a cellular phone antenna according to the present invention;

FIG. 3 is a perspective view illustrating a connection terminal after it is attached to a cellular phone antenna according to the present invention; and

FIG. 4 is a flow chart of a manufacturing process of a cellular phone antenna according to the present invention.

### BEST MODE

The preferred embodiments of the present invention will be described with reference to the accompanying drawings.

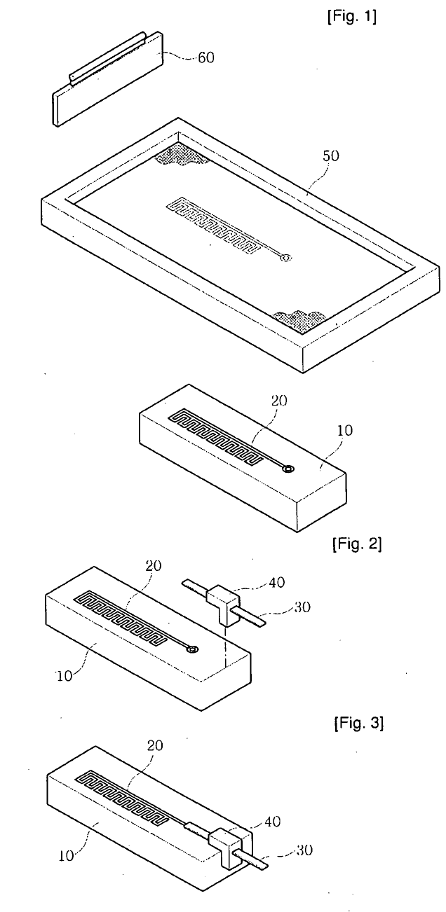

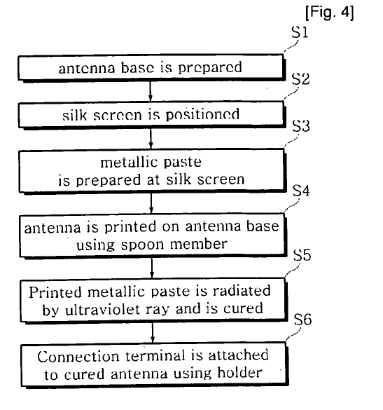

FIG. 1 is a perspective view illustrating a silk screen used for manufacturing a cellular phone antenna according to the present invention. FIG. 2 is a perspective view illustrating a connection terminal before it is attached to a cellular phone antenna according to the present invention. FIG. 3 is a perspective view illustrating a connection terminal after it is attached to a cellular phone antenna according to the present invention. FIG. 4 is a flow chart of a manufacturing process of a cellular phone antenna according to the present invention.

As shown in FIGS. 1 through 4, in a cellular phone antenna engaged in an interior of a cellular phone, there is provided a cellular phone antenna which comprises an antenna base 10 which is engaged in an interior of a cellular phone; an antenna 20 which is installed at the antenna base 10; a connection terminal 30 which is connected with the antenna 20; and a holder 40 which is attached to the antenna base 10 so that the antenna 20 and the connection terminal 20 are connected.

Here, the antenna base 10 is made of a synthetic resin, preferably made of a polycarbonate having a high hardness and tensional strength. The antenna 20 is printed on an upper surface of the antenna base 10 by a spoon member 60 in an antenna shape, with the screen device 50 being provided with a metallic paste. A silk screen is formed on the silk screen device 50 in an antenna shape. The metallic paste may be formed of silver or copper.

The paste is made in a salve type by mixing metallic powder and a base, which is an adhesive. Here, the metallic powder has nano sizes.

Since the metal (silver or copper) used for the paste is hardened at 75° C. and is cured, the antenna base 10 made of synthetic resin coated with paste is not transformed. In addition, the paste is hardened and cured by radiating ultraviolet ray to the paste.

The manufacturing method of the cellular phone antenna according to the present invention will be described.

As shown in FIG. 4, a rectangular antenna base 10 is prepared in a step S1. A silk screen device 50 is positioned on the upper side of the antenna base 10 for printing a certain shape in a step S2. A metallic paste is provided at the silk screen device 50 by a certain amount in a step S3. The metallic paste is printed in a certain shape on the upper side of the antenna base 10 by reciprocating the spoon member 60 in a step S4. The metallic paste is hardened and cured by radiating ultraviolet ray to the metallic paste printed on the antenna base 10 or using heat of 75° C. in a step S5. A holder 40 engaged with a connection terminal 30 is attached at one side of the antenna base 10 using a certain adhesive so that the connection terminal 30 is connected with the antenna 20 in a step S6.

Here, an adhesive is preferably made of cyanoacrylate having a fast drying speed and a good adhesive strength. An interconnection portion is processed with silver paste so that the connection terminal 30 and the antenna 20 are permanently connected.

### INDUSTRIAL APPLICABILITY

As described above, since the antenna according to the present invention is manufactured in a state that an external force is not applied, the antenna is not transformed, so that a high frequency characteristic is not changed, and a degradation problem does not occur. So, the present invention is a very reliable invention.

In addition, a good high frequency characteristic and product safety are obtained since a cellular phone antenna is manufactured in such a manner that an antenna device is not transformed.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. In a cellular phone antenna engaged in an interior of a cellular phone, a cellular phone antenna, comprising:
an antenna base (10) which is engaged in an interior of a cellular phone;
an antenna (20) which is installed at the antenna base (10);
a connection terminal (30) which is connected with the antenna (20); and
a holder (40) which is attached to the antenna base (10) so that the antenna (20) and the connection terminal (20) are connected.

2. The antenna of claim 1, wherein said antenna (20) is provided with a metallic paste and is printed on the antenna base (10) by a silk screen method.

3. A manufacturing method of a cellular phone antenna, comprising:
a step S1 in which a rectangular antenna base (10) is prepared;
a step S2 in which a silk screen device (50) is provided at an upper side of the antenna base (10) for printing in a certain shape;
a step S3 in which a metallic paste is provided at the silk screen device (50);
a step S4 in which the metallic paste is printed on the upper side of the antenna base (10) in a certain shape using a spoon member (60);
a step S5 in which the metallic paste printed on the antenna base (10) is hardened and cured; and
a step S6 in which a holder (40) engaged with the connection terminal (30) is attached at the antenna base (10) so that the connection terminal (30) is connected with the antenna (20) hardened on the antenna base (10).

4. The method of claim 3, wherein said step for hardening and curing the metallic paste is performed using a temperature of 75° C. or ultraviolet ray.
